(19) United States
(12) Patent Application Publication
(10) Pub. No.: US 2016/0348429 A1
(43) Pub. Date: Dec. 1, 2016

(54) PANEL SHUTTER WITH A DEFORMATION DETECTION ARRANGEMENT

(71) Applicant: ASSA ABLOY ENTRACE SYSTEMS AB, Landskrona (SE)

(72) Inventor: Friedhelm Frede, Erwitte (DE)

(21) Appl. No.: 15/108,330

(22) PCT Filed: Feb. 17, 2015
(86) PCT No.: PCT/EP2015/053321

§ 371 Date: Jun. 27, 2016

(30) Foreign Application Priority Data
Feb. 19, 2014 (SE) 1450205-8

(51) Int. Cl. E06B 9/88; E06B 9/17; E06B 9/15; E06B 9/58; E06B 9/68

(52) U.S. Cl. CPC E06B 9/88; E06B 9/58; E06B 9/68; E06B 9/15; E06B 9/17076; E06B 2009/6836; E06B 2009/6809; E06B 2009/1566; E06B 2009/17084

(57) ABSTRACT

The invention relates to a panel shutter (10) for opening and closing a doorway (15) having a door blade (11), the door blade (11) comprises several rigid shutter elements (12) which are hinged with each other. Further damage to the panel shutter (10) caused by a deformation (22) of the door blade (11) and/or at least one shutter element (12) is avoided by a detection arrangement (24) for detecting a deformation (22) of at least one shutter element (12).

The invention relates to a panel shutter for opening and closing a doorway having a door blade, the door blade comprises several rigid shutter elements which are hinged with each other.

Such a panel shutter or rollup door is known from document US 2011/0265959 A1.

Panel shutters or rollup doors may be used in industrial facilities, such as factories, warehouses, garages, and the like to selectively cover doorways or guard machinery in order to provide security, as well as protection from debris and/or unwanted climatic variations.

A drawback of the known panel shutters, preferably of high speed roller doors with rigid shutter elements, is that a deformation in a shutter element and/or a deformed shutter element could cause further damage to the panel shutter. A deformation directed to the inside could damage the inner layer of a rolled up door blade. A deformation directed to the outside could touch a wall, a lintel or a lintel profile. Thus, a deformation of the door blade or at least one shutter element may lead to a serious malfunction and/or serious damages of the panel shutter. At worst a shutter element with a deformation to the outside hit the lintel or lintel profile which may torn the deformed shutter element off the door blade.

It is therefore a principal object of the present invention to enhance a panel shutter as mentioned in the preceding introduction such that further damage to the panel shutter caused by a deformation of the door blade and/or at least one shutter element is avoided.

The object of the invention is accomplished by a panel shutter as mentioned in the preceding introduction, wherein a detection arrangement for detecting a deformation of at least one shutter element is provided. The detection arrangement detects if a deformation is present in at least one shutter element. Consequently, if a deformation is present in at least one of the shutter elements of the panel shutter it is detected by the detection arrangement. Thus, the panel shutter is provided with a detection arrangement, wherein the detection arrangement detects if a deformation is present in at least one shutter element.

As an advantageous result a deformation of at least one shutter element and/or the door blade is detectable by the detection arrangement. Upon detection of a deformation the normal operation of the panel shutter may be altered to avoid any damage by the deformation. A deformation may be a dent, a fold, a bump and/or a buckle on the shutter element. Furthermore, the deformation may be realized by a deformed and/or bent shutter element.

Within the scope of this invention a panel shutter may be a roller shutter and/or a sectional door. Preferably a panel shutter comprises several rigid shutter elements as panels and/or lamellas. This shutter elements may form the door blade such that the door blade is moveable at least in a vertical direction for opening and closing the doorway. Preferably the hinged connection of the shutter elements to each other allows the door blade to be rolled up on and/or unrolled of a coiling device of a roller shutter. In case of a sectional door the hinged connection of the shutter elements may allow the transition of the door blade from the substantially vertical plane of the doorway into a substantially horizontal plane, preferably under a ceiling and/or for opening the doorway, and vice versa.

Preferably the detection arrangement has a transmitter receiver assembly for detecting a deformation of at least one shutter element. The transmitter receiver assembly may monitor the door blade and/or the shutter elements for recognizing a deformation which may cause further damage to the panel shutter. The transmitter receiver assembly may be arranged such that only deformations are recognized or detected which extends a predetermined size. The transmitter receiver assembly comprises at least one transmitter and at least one receiver. Preferably the transmitter is designed and arranged to emit a detection signal towards the receiver which is designed and arranged for receiving the detection signal. The transmitter receiver assembly may be arranged at side rails for guiding the shutter elements. The transmitter receiver assembly may be assigned to the outer side of the panel shutter and/or door blade for detecting a deformation extending outwards. In an alternative embodiment the transmitter receiver assembly may be assigned to the inner side of the panel shutter and/or door blade for detecting a deformation extending inwards. In a further alternative embodiment a first transmitter receiver assembly may be assigned to the outer side of the panel shutter and a second transmitter receiver assembly may be assigned to the inner side of the panel shutter.

According to a further embodiment of the present invention a transmitter of the detection arrangement is arranged at an inner side of a first side rail and a receiver of the detection arrangement is arranged at an inner side of a second side rail. Preferably the door blade and/or the shutter elements are guided by and between the first and second side rail. The transmitter and/or the receiver may be embedded or sunken in the side rails. A position of the transmitter and/or receiver inside the side rails protects the transmitter and/or receiver respectively against contamination and/or damages. Preferably the transmitter and the receiver are turned towards each other to detect a deformation of at least one shutter element and/or the door blade in a pathway of a detection signal from the transmitter to the receiver. A deformation may be recognized or detected in case that the detection signal is interrupted. If the receiver does not receive the detection signal this may indicate a deformation.

Preferably the transmitter is oriented to emit a detection signal substantially parallel to a plane of a closed door blade and/or a plane of the doorway towards the receiver. The detection signal may be a beam which is emitted by the transmitter towards the receiver. Preferably the detection signal is aligned substantially horizontally and may be directed over the whole width of the door blade and/or doorway. The transmitter receiver assembly can be arranged in the upper half or upper third of the doorway.

The transmitter receiver assembly may comprise a transmitter receiver unit and a reflector. The transmitter receiver unit combines a transmitter and a receiver within one device. The reflector may be formed as a mirror. Preferably the transmitter receiver unit is arranged at an inner side of a first side rail and a reflector is arranged at an inner side of a second rail. Especially preferred the reflector is arranged for reflecting a detection signal received from the transmitter back to the receiver.

According to a further embodiment the transmitter receiver assembly, the transmitter receiver unit, the reflector, the transmitter and/or the receiver are arranged with a predetermined horizontal distance to the door blade in a closed position for allowing a predetermined deflection of a shutter element without being detected. The transmitter receiver assembly, the transmitter receiver unit, the reflector, the transmitter and/or the receiver may be arranged at the side rails with a predetermined horizontal distance to the door blade in a closed position for allowing a predetermined deflection of a shutter element without being detected. Such a deflection may be caused by wind load or a different pressure source acting on the door blade. As the transmitter receiver assembly and/or the detection signal is horizontally distanced to the door blade and/or the shutter element a deflection with an extent less the horizontal distance may not be detected. Thus, such a minor deflection will not affect normal operation of the panel shutter.

Preferably the horizontal distance from the transmitter receiver assembly, the transmitter receiver unit, the reflector, the transmitter and/or the receiver to the door blade in a closed position is in the range of 10 mm to 100 mm. Particularly the detection signal has a horizontal distance to the closed door blade and/or a shutter element in the doorway in the range of 10 mm to 100 mm. Especially preferred is a horizontal distance in the range of 30 mm to 50 mm, particularly a horizontal distance of 40 mm. Thus, a deflection extending out of the plane of the door blade less than the horizontal distance will not be detected by the transmitter receiver assembly.

According to a further embodiment the transmitter receiver assembly, the transmitter receiver unit, the reflector, the transmitter and/or the receiver are arranged with a predetermined vertical distance to an upper end of the doorway for realizing a stopping distance. The transmitter receiver assembly, the transmitter receiver unit, the reflector, the transmitter and/or the receiver is thereby stationary. The transmitter receiver assembly, the transmitter receiver unit, the reflector, the transmitter and/or the receiver may be arranged at the side rails with a predetermined vertical distance to an upper end of the doorway for realizing a stopping distance. The upper end of the doorway may be defined by a lintel of the doorway and/or a lintel profile of the panel shutter. Preferably the vertical distance and/or stopping distance allows to stop up rolling the door blade after detecting a deformation and before the deformation reaches the upper end of the doorway, a lintel of the doorway and/or a lintel profile of the panel shutter. The vertical distance and/or stopping distance may depend on the speed of the door blade, braking time for stopping a driven door blade, the size of the door blade and/or the weight of the door blade.

Preferably the vertical distance from the transmitter receiver assembly, the transmitter receiver unit, the reflector, the transmitter and/or the receiver to the upper end of the doorway, preferably to a lintel of the doorway and/or a lintel profile of the panel shutter, is in the range of 300 mm to 1000 mm. Especially preferred is a vertical distance in the range of 400 mm to 700 mm, particularly a vertical distance of 500 mm. Thus, deformations above the transmitter receiver assembly and/or the detection signal may not be recognized by the detection arrangement. However, most deformations are usually located in the lower half of the door blade. Such deformations may be caused by a collision with a fork lift or another vehicle or object.

Preferably, the detection arrangement is stationary. Thereby, the detection arrangement has a stationary position as opposed to the movable door blade. Thus, possible deformations in a plurality of shutter elements, such as possible deformations in at least two shutter elements, can be detected. In particular can deformations below the transmitter receiver assembly and/or the detection signal, such as deformations in shutter elements below the transmitter receiver assembly, be detected. Deformations in all shutter elements below the transmitter receiver assembly may be detected., e.g. shutter elements below the predetermined vertical distance to the upper end of the doorway, can be detected. This applies especially to shutter elements located below the transmitter receiver assembly and/or the detection signal when the door blade is in a closed position. The transmitter receiver assembly, the transmitter receiver unit, the reflector, the transmitter and/or the receiver may be stationary. The transmitter receiver assembly, the transmitter receiver unit, the reflector, the transmitter and/or the receiver may be stationary arranged at the side rails.

According to another embodiment the detection arrangement is coupled to a controller and/or a control system. The controller may be connected to the transmitter, the receiver and/or a drive for driving the door blade and/or a coiling device for selectively unroll or up roll the shutter elements of the door blade. Preferably the controller is configured to enable a transmitter for emitting a detection signal. The controller may be configured to receive a signal from a receiver. Preferably the controller monitors or controls if the receiver is receiving the detection signal from the transmitter. Especially preferred the controller controls, triggers and/or activates a detection reaction in case a deformation is detected.

The elements of the transmitter receiver assembly, preferably the transmitter receiver unit, the reflector, the transmitter and/or the receiver may be selectively arranged at the left side or the right side of the panel shutter respectively.

The detection reaction may be a sound, an audio alarm, a light signal and/or a stopping of a movement of the door blade. Preferably the detection reaction comprises automatically stopping an up rolling movement of the door blade and/or unrolling the door blade for closing the doorway. This reduces the risk that the detected deformation contacts the upper end of the doorway or another element of the panel shutter. The risk of additional damages is considerably reduced. Especially preferred is unrolling the door blade with a speed which is less than the normal operation speed of the door blade. This further reduces the risk of additional damages.

According to another embodiment of the invention a detection arrangement is arranged at the outer side of the doorway for detecting at least one deformation extending to the outside. Most deformations origin from a collision with a vehicle or an object with the inner side of the door blade leading to a deformation extending outwards. Preferably a first transmitter receiver assembly is arranged at the outer side of the doorway for detecting at least one deformation extending to the outside and a second transmitter receiver assembly is arranged at the inner side of the doorway for detecting at least one deformation extending to the inside. By providing a first and second transmitter receiver assembly deformations extending outwards as well as deformations extending inwards can be detected.

Preferably a detection signal of the detection arrangement is an electromagnetic wave, a light beam, an infrared beam and/or an ultrasound beam. The detection signal may be a directed beam transmitted from the transmitter in a linear pathway towards the receiver. According to an alternative instead of a light beam or a single beam of light a light grid and/or a light curtain may be used. The light grid and/or light curtain may comprise a plurality of light beams. The plurality of light beams may be arranged such that the light beams are emitted parallel to each other by the transmitter receiver assembly. Preferably the plurality of light beams are aligned on above the other with a predetermined distance between them. A deformation may be detected in case of one light beam of the light grid and/or light curtain is interrupted.

According to a further embodiment the shutter elements are formed as panels and/or lamellas which are connected with each other by flexible joints for rolling up and unrolling the door blade around a coiling device. Preferably the shutter elements are foamed lamellas and/or foamed sandwich panels. Such a panel or lamella can be produced with low costs, provides very good thermal insulation, has good stiffness properties leading to only small deflections when a wind load is acting and has a low weight per square meter. In an alternative the shutter elements may be made of metal, aluminium and/or plastic.

The panel shutter may be a high speed roller door. Preferably the door blade of the high speed roller door is moved in normal operation with a speed in the range of 0.5 m/s to 5 m/s. Especially preferred is a speed in normal operation in the range of 1 m/s to 3 m/s, particularly a speed of 2 m/s. A deformation in a door blade and/or a shutter element of a high speed roller door may cause serious problems and/or damages. Thus, a detection arrangement according to the present invention is especially advantageous in combination with a high speed roller door.

The following detailed description, given by way of example and not intended to limit the present invention solely thereto, will best be appreciated in conjunction with the accompanying figures, wherein like reference numerals denote like elements and parts, in which:

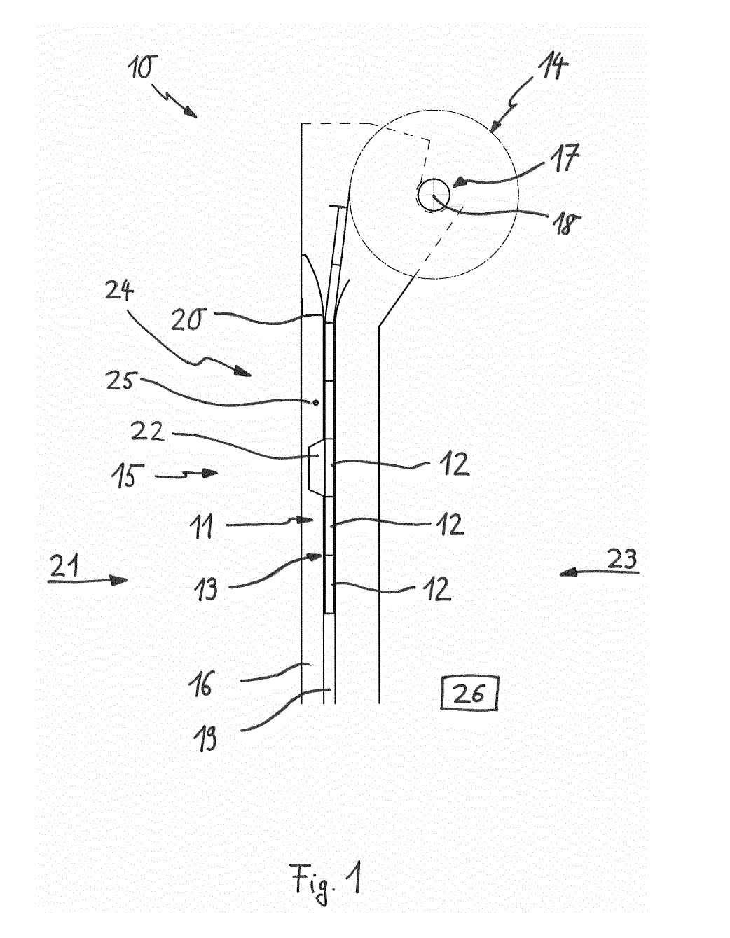

FIG. 1 is a cross section of a schematic side view of a panel shutter according to the present invention,

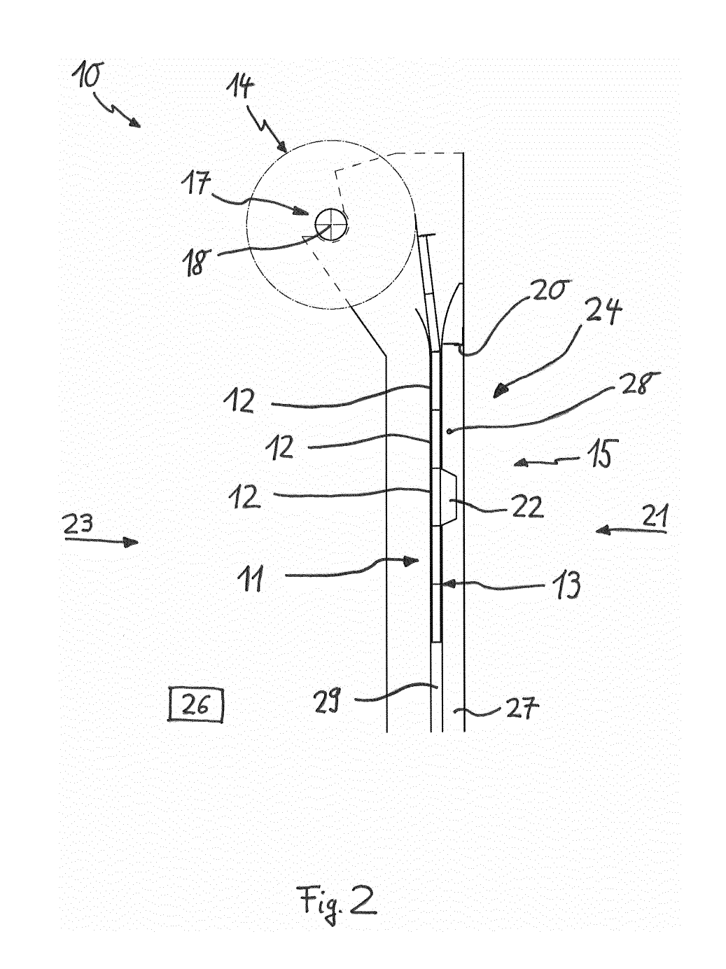

FIG. 2 is a further cross section of a schematic side view of the panel shutter according to the present invention,

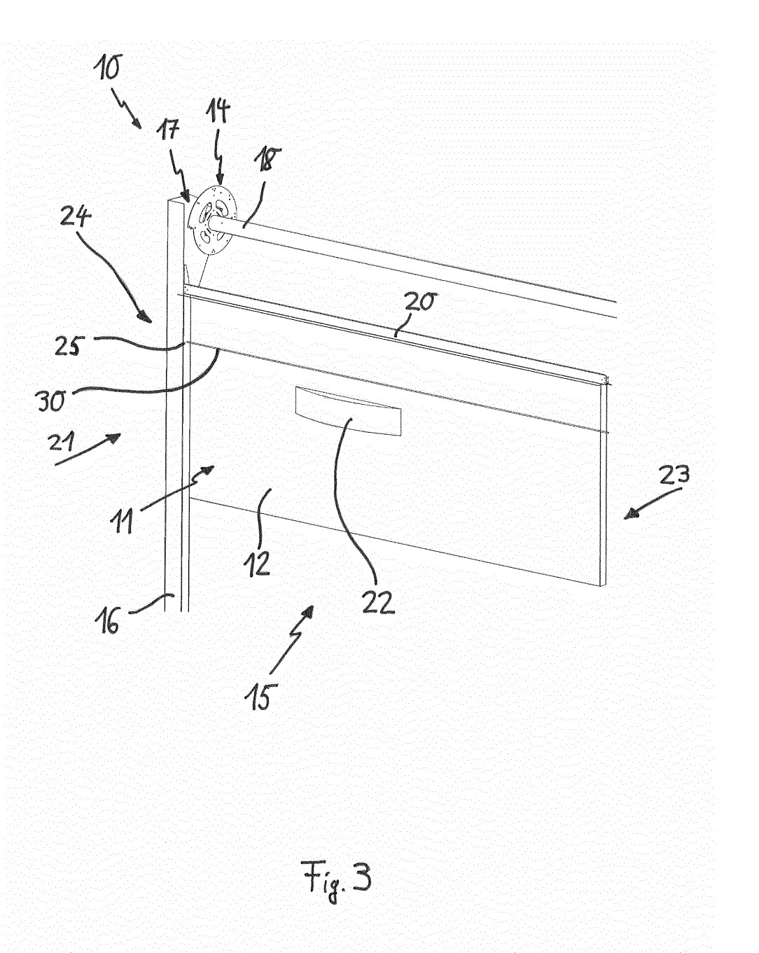

FIG. 3 is a schematic perspective view of a section with partial removed elements of the panel shutter according to the invention,

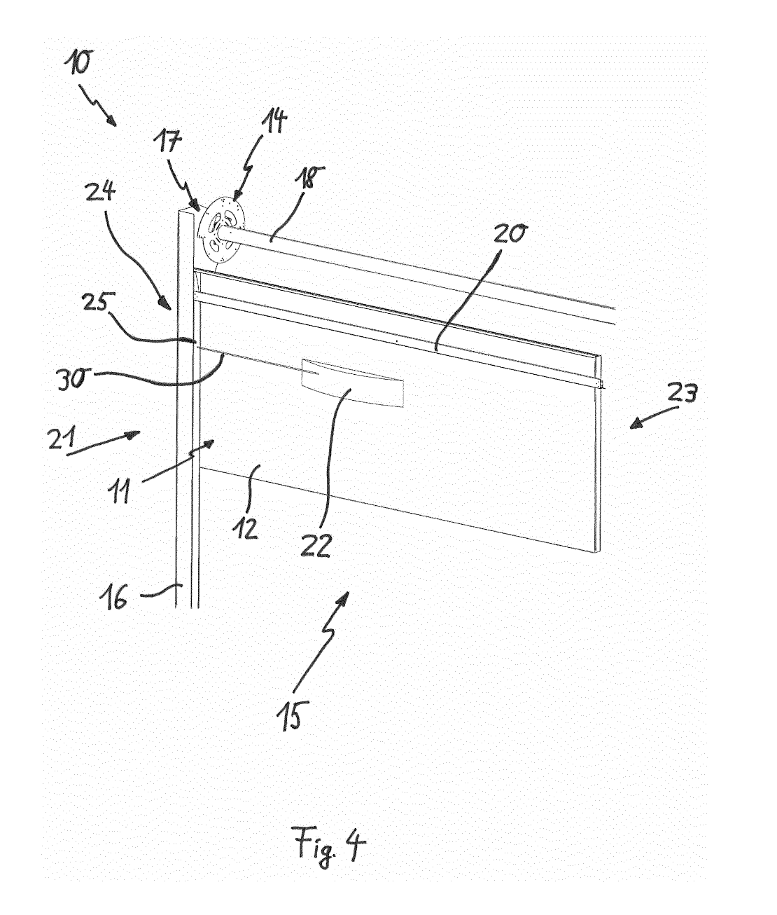

FIG. 4 is a further schematic perspective view of a section with partial removed elements of the panel shutter according to the invention, and

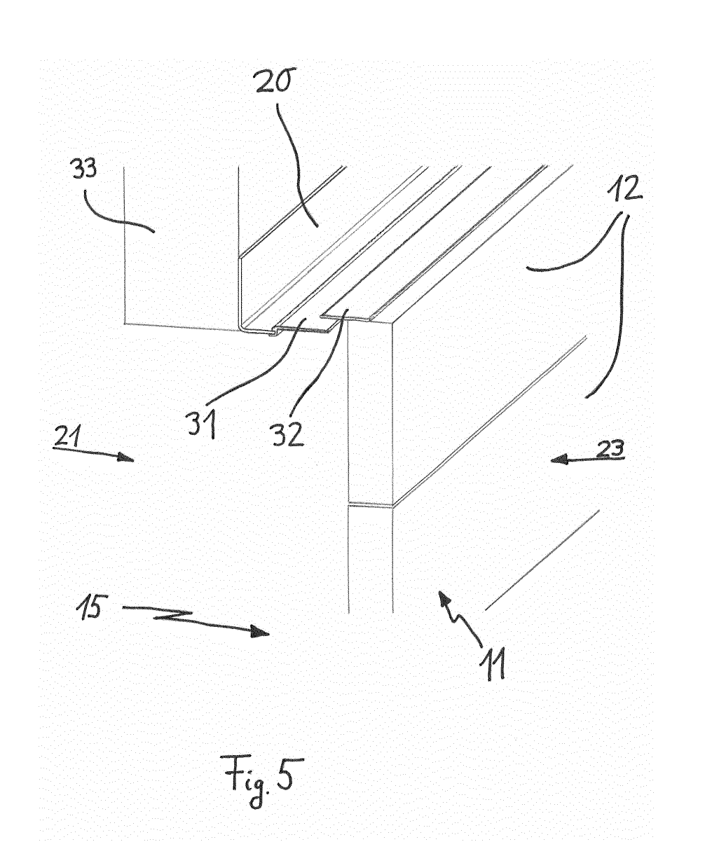

FIG. 5 is a schematic perspective view of a detail at an upper end of a doorway of the panel shutter according to the invention.

The present invention will now be described more fully hereinafter with reference to the accompanying figures in which preferred embodiments of the invention are shown. This invention may, however, be embodied in many different forms and should not be construed as limited to the illustrated embodiments set forth herein. Rather, these illustrated embodiments are provided so that this disclosure will be thorough and complete, and will fully convey the scope of the invention to those skilled in the art.

The panel shutter will be described as a high speed roller door selectively blocking or opening a doorway. This recitation is for convenience only. It would be understood by one skilled in the art that such a roller door or rollup door is suitable for many embodiments and/or applications, including but not limited to industrial high speed rollup doors, interior doorway covering, exterior doorway covering, etc.

FIG. 1 is a cross section of a schematic side view of a panel shutter 10 according to the present invention. The panel shutter 10 is a high speed roller door and has a door blade 11. The door blade 11 comprises several rigid shutter elements 12. In this embodiment the shutter elements 12 are designed as foamed lamellas which are hinged with each other by flexible joints 13. For greater clarity not all shutter elements 12 and flexible joints 13 provide a reference number and not all shutter elements 12 and flexible joints 13 are shown. The flexible joints 13 allows a rotation of adjacent shutter elements 12 to each other along a substantially horizontal axis. Furthermore, the flexible joints 13 allows up rolling and unrolling of the door blade 11 in regard to a coiling device 14. The coiling device 14 is connected with a drive 17 for rotating the coiling device 14 around its longitudinal axis 18.

On a first side of a doorway 15 a first side rail 16 is mounted for guiding the shutter elements 12 within a channel 19. The upper end of the doorway 15 is defined by a lintel profile 20. The lintel profile 20 is assigned to an outer side 21 of the panel shutter 10. In this embodiment one of the shutter elements 12 has a schematic shown deformation 22 which extends to the outer side 21 or out of the outside of door blade 11. Such a deformation 22 may be the result of a collision with an object, for example a fork lift, which has impacted the shutter element 12 at the inner side 23 of the panel shutter 10.

The panel shutter 10 comprises a detection arrangement 24 for detecting a deformation 22. The detection arrangement 24 has a transmitter 25 which is mounted at the inner side of the first side rail 16. The transmitter 25 is arranged at the outer side 21 of the panel shutter 10. In this embodiment the transmitter 25 is horizontally distanced from the outside of the door blade 11 in a closed position with a horizontal distance of 40 mm. Furthermore, the transmitter 25 is arranged below the lintel profile 20 with a vertical distance of 500 mm. The transmitter 25 is stationary mounted at the first side rail 16.

The transmitter 25 is connected with a controller 26. The controller 26 is configured to activate the transmitter 25 such that the transmitter 25 emits a detection signal (not shown). The drive 17 is also connected with the controller 26. The controller 26 will stop the drive 17 upon noticing a deformation 22.

FIG. 2 is a further cross section of a schematic side view of the panel shutter 10 according to the present invention. As far as identical elements with identical reference numbers are concerned reference is made to the above mentioned description. FIG. 2 looks like a mirrored version of FIG. 1, but shows in contrast to FIG. 1 a second side of the doorway 15 with a second side rail 27. The second side rail 27 has a channel 29 in which the shutter elements 12 are guided. The first side rail 16 and the second side rail 27 and their channels 19, 29 are faced towards each other. The door blade 11 is guided between the first and second side rail 16, 27 for blocking and opening the doorway 15.

In place of a transmitter 25 the second side rail comprises a receiver 28. The receiver 28 is part of the detection arrangement 24. In this embodiment the receiver 28 is horizontally distanced from the outside of the door blade 11 in a closed position with a horizontal distance of 40 mm. Furthermore, the receiver 28 is arranged below the lintel profile 20 with a vertical distance of 500 mm. Thus, the transmitter 25 and the receiver 28 are faced towards each other. The receiver 28 is connected with the controller 26. In case that the receiver 28 is not receiving a detection signal from the transmitter 25, the controller 26 generates a detection reaction like an alarm signal and/or alarm action. In this embodiment an alarm action is generated including stopping any movement of the door blade 11, reversing the movement of the door blade 11, emitting a sound and visible alarm. The receiver 28 is stationary mounted at the second side rail 27.

FIG. 3 is a schematic perspective view of a section with partial removed elements of the panel shutter 10 according to the invention. The transmitter 25 emits a detection signal 30 parallel to the plane of the at least partial closed door blade 11 to the receiver 28 (not shown). The deformation 22 is below the detection signal 30. As the detection signal 30 is not interrupted by the deformation 22 a movement of the door blade 11 for unrolling or up rolling the door blade 11 is feasible.

FIG. 4 is a further schematic perspective view of a section with partial removed elements of the panel shutter 10 according to the invention. In contrast to FIG. 3 the door blade 11 has been moved upwards to up roll the door blade 11 around the coiling device 14. The deformation 22 of the shutter element 12 crosses the pathway of the detection signal 30. Thus, the detection signal 30 from the transmitter 25 to the receiver 28 is interrupted. In this case the controller 26 (not shown) causes the drive 17 to stop. The vertical distance from the transmitter 25, the receiver 28 and the detection signal 30 to the upper end of the doorway 15 is such that the movement of the door blade 11 stops before the deformation 22 may hit the lintel profile 20.

FIG. 5 is a schematic perspective view of a detail at an upper end of doorway 15 of the panel shutter 10 according to the invention. The lower end of the lintel profile 20 defines the upper end of doorway 15. The lintel profile 20 is mounted to the lintel 33 of a wall. Between the lintel profile 20 and the door blade 11 or the upper shutter element 12 is a horizontal gap. This gap is closed by two sealing profiles 31, 32 when the door blade 11 is in its lowest position for totally blocking the doorway 15.

A lintel sealing profile 31 is mounted to the lintel profile 20. The lintel sealing profile 31 is extending substantially horizontally from the lintel profile 20 towards the door blade 11. A door blade sealing profile 32 is mounted to the upper end of the door blade 11. The door blade sealing profile 32 is extending substantially horizontally from the upper end of the door blade 11 towards the lintel profile 20. When the door blade 11 is in its lowest position or is fully unrolled to block the doorway 15 completely, the lintel sealing profile 31 and the door blade sealing profile 32 overlap and contact each other. Thus, the horizontal gap between the lintel profile 20 and the door blade 11 is completely sealed or closed when the door blade 11 is completely unrolled.

A wind load or pressure on the inner side 23 of the door blade 11 lead to a deflection of the door blade 11 or the shutter elements 12. Because of the horizontal gap between the lintel profile 20 and the door blade 11 in conjunction with the flexible lintel sealing profile 31 and the flexible door blade sealing profile 32 the door blade 11 can pass the lintel profile 20 without contacting it.

If the door blade 11 or the shutter element 12 has a deformation 22 which extends to the outside in a range smaller than the gap between the lintel profile 20 and the door blade 11, preferably without any additional wind load acting on the inner side 23, the door blade 11 can still be rolled up as long as the deformation 22 does not interrupt the detection signal 30.

In an alternative within the scope of the invention the detection arrangement 24 may comprise in addition to the first transmitter 25 and the first receiver 26 at the outside of the panel shutter 10 a second transmitter and a second receiver. The second transmitter and the second receiver may be identical to the first transmitter 24 and the first receiver 26 respectively. However, in contrast to the first transmitter 24 and first receiver 26 the second transmitter and second receiver are arranged on the inner side 23 of the panel shutter 10. Thus, the second transmitter and second receiver are arranged to detect a deformation of a shutter element 12 extending to the inner side 23 or out of the inside of door blade 11. Such a deformation 22 may be caused by a collision with an object, for example a fork lift, which has impacted the shutter element 12 at the outer side 21 of the panel shutter 10.

The arrangements of the transmitter 25 and the receiver 26 may be interchanged such that the transmitter 25 is arranged at the second side rail 27 and the receiver 26 is arranged at the first side rail 16. The arrangements of the second transmitter and the second receiver may be also freely selected such that the second transmitter and second receiver may be arranged at the first side rail or second side rail respectively.

Although preferred embodiments of the present invention and modifications thereof have been described in detail herein, it is to be understood that this invention is not limited to these precise embodiments and variations and may be effected by one skilled in the art without departing from the spirit and scope of the invention as defined by the appended claims.

The use of expressions like: “particularly”, “preferably” or “especially preferred” etc. is not intended to limit the invention. Features which are not specifically or explicitly described or claimed may be additionally included in the structure or method according to the present invention without deviating from its scope.

### REFERENCE NUMERALS

10 panel shutter

11 door blade

12 shutter element

13 flexible joint

14 coiling device

15 doorway

16 first side rail

17 drive

18 axis

19 channel

20 lintel profile

21 outer side

22 deformation

23 inner side

24 detection arrangement

25 transmitter

26 controller

27 second side rail

28 receiver

29 channel

30 detection signal

31 lintel sealing profile

32 door blade sealing profile

33 lintel

1. Panel shutter for opening and closing a doorway having a door blade, the door blade comprises several rigid shutter elements which are hinged with each other, comprising a detection arrangement for detecting a deformation of at least one shutter element.

2. Panel shutter according to claim 1, wherein the detection arrangement has a transmitter receiver assembly for detecting a deformation of at least one shutter element, wherein the transmitter receiver assembly is arranged at side rails for guiding the shutter elements.

3. Panel shutter according to claim 1, wherein a transmitter of the detection arrangement is arranged at an inner side of a first side rail and a receiver of the detection arrangement is arranged at an inner side of a second side rail, wherein the transmitter and the receiver are turned towards each other to detect a deformation of at least one shutter element in a pathway of a detection signal from the transmitter to the receiver.

4. Panel shutter according to claim 3, wherein the transmitter is oriented to emit a detection signal substantially parallel to a plane of a closed door blade towards the receiver, wherein the detection signal is aligned horizontally.

5. Panel shutter according to claim 2, wherein the transmitter receiver assembly comprise a transmitter receiver unit and a reflector, wherein the transmitter receiver unit is arranged at an inner side of a first side rail and a reflector is arranged at an inner side of a second rail, especially preferred the reflector is arranged for reflecting a detection signal received from the transmitter back to the receiver.

6. Panel shutter according to claim 2, wherein the transmitter receiver assembly, the transmitter and/or the receiver are arranged at the side rails with a predetermined horizontal distance to the door blade in a closed position for allowing a predetermined deflection of a shutter element without being detected, wherein the horizontal distance from the transmitter receiver assembly, the transmitter and/or the receiver to the door blade in a closed position is in the range of 10 mm to 100 mm, especially preferred is a horizontal distance in the range of 30 mm to 50 mm, particularly a horizontal distance of 40 mm.

7. Panel shutter according to claim 2, wherein the transmitter receiver assembly, the transmitter and/or the receiver are arranged at the side rails with a predetermined vertical distance to an upper end of the doorway, preferably to a lintel of the doorway and/or a lintel profile of the panel shutter, for realizing a stopping distance, preferably the stopping distance allows to stop up rolling the door blade after detecting a deformation and before the deformation reaches the upper end of the doorway, especially preferred a lintel of the doorway and/or a lintel profile of the panel shutter.

8. Panel shutter according to claim 7, wherein the vertical distance from the transmitter receiver assembly, the transmitter and/or the receiver to the upper end of the doorway, preferably to a lintel of the doorway and/or a lintel profile of the panel shutter, is in the range of 300 mm to 1000 mm, especially preferred is a vertical distance in the range of 400 mm to 700 mm, particularly a vertical distance of 500 mm.

9. Panel shutter according to claim 1, wherein the detection arrangement is coupled to a controller, preferably wherein the controller is configured to enable a transmitter to emit a detection signal and/or the controller is configured to receive signals from a receiver, especially preferred the controller controls a detection reaction in case a deformation is detected.

10. Panel shutter according to claim 9, wherein the detection reaction is a sound, an audio alarm, a light signal and/or a stopping of any movement of the door blade, wherein the detection reaction comprises stopping of an up rolling movement of the door blade and unrolling the door blade for closing the doorway, especially preferred is unrolling the door blade with a speed which is less than the normal operation speed of the door blade.

11. Panel shutter according to claim 1, wherein a detection arrangement is arranged at the outer side of the doorway for detecting a deformation extending to the outside, preferably wherein a first transmitter receiver assembly is arranged at the outer side of the doorway for detecting a deformation extending to the outside and a second transmitter receiver assembly is arranged at the inner side of the doorway for detecting a deformation extending to the inside.

12. Panel shutter according to claim 1, wherein a detection signal of the detection arrangement is an electromagnetic wave, a light beam, an infrared beam and/or an ultrasound beam.

13. Panel shutter according to claim 1, wherein the shutter elements are formed as panels and/or lamellas which are connected with each other by flexible joints for rolling up and unrolling the door blade around a coiling device, wherein the shutter elements are foamed lamellas.

14. Panel shutter according to claim 1, wherein the panel shutter is a high speed roller door, preferably the door blade of the high speed roller door is moved in normal operation with a speed in the range of 0.5 m/s to 5 m/s, especially preferred is a speed in normal operation in the range of 1 m/s to 3 m/s, particularly a speed of 2 m/s.
